(19) United States
(12) Patent Application Publication
(10) Pub. No.: US 2010/0021879 A1
(43) Pub. Date: Jan. 28, 2010

(54) COMPOSITIONS AND METHODS FOR PRESERVING RED BLOOD CELLS

(75) Inventors: Maria Carolina Delgado, Doral, FL (US); Bertram Pitt, Ann Arbor, MI (US)

Correspondence Address: Casimir Jones, S.C., 2275 DEMING WAY, SUITE 310, MIDDLETON, WI, 53562, US

(73) Assignee: THE REGENTS OF THE UNIVERSITY OF MICHIGAN, Ann Arbor, MI (US)

(21) Appl. No.: 12/521,639

(22) PCT Filed: Jan. 17, 2008
(86) PCT No.: PCT/US08/51324

§ 371 Date: Jun. 29, 2009

Related U.S. Application Data
(60) Provisional application No. 60/881,273, filed on Jan. 19, 2007.

(51) Int. Cl. A01N 1/02

(52) U.S. Cl. 435/2

(57) ABSTRACT

The present invention provides methods, compositions and kits for storing red blood cells for extended periods of time. In particular, the present invention provides methods, compositions and kits for storing red blood cells for extended periods of time while preventing red blood cell storage lesions, retaining red blood cell deformability, and increasing survival of the red blood cells following transfusion.

### CROSS-REFERENCE TO RELATED APPLICATIONS

The present application is a Section 371 U.S. national stage of pending International Patent Application No. PCT/US2008/051324, International Filing Date Jan. 17, 2008, which claims the benefit of expired Provisional Patent Application No. 60/881,273, filed Jan. 19, 2007, all of which are hereby incorporated by reference in their entireties.

### STATEMENT REGARDING FEDERALLY SPONSORED RESEARCH OR DEVELOPMENT

None.

### FIELD OF THE INVENTION

The present invention provides methods, compositions and kits for storing red blood cells for extended periods of time. In particular, the present invention provides methods, compositions and kits for storing red blood cells for extended periods of time while preventing red blood cell storage lesions, retaining red blood cell deformability, and increasing survival of the red blood cells following transfusion.

### BACKGROUND

Transfusion of red blood cells (RBC) is associated with increased morbidity and mortality for both medical and surgical patients. Transfusions have been associated with transmission of infectious agents, postoperative infectious complications, sternal wound infections, postoperative pneumonia, renal dysfunction, impaired postoperative pulmonary function, multiple organ failure, acute respiratory stress syndrome, increased intensive care unit and hospital length of stay, and increased short- and long-term mortality (see, e.g., Marik P E, et al., 1993 JAMA 269:3024-3029; Martin C M, et al., 1994 Clin Invest Med 17(Suppl 4):B21; Purdy F R, et al., 1997 Can J Anaesth 1997; 44:1256-1261; Zallen G, et al., 1999 Am J Surg 178:570-572; Vamvakas E C, et al., 1999 Transfusion 39:701-710; Vamvakas E C, et al., 2000 Transfusion 40:101-109; Walsh T S, et al., 2001 Eur Soc Intensive Care Med 27:S247; Offner P J, et al., 2002 Arch Surg 137:711-717; Leal-Noval S R, et al., 2003 Anesthesiology 98:815-822; Koch, et al., 2006 Crit. Care Med. 34(6):1608-1616; each incorporated herein in their entireties). Many of these adverse effects are attributed to changes that occur in the red blood cell product during prolonged ex vivo storage of blood.

Improved methods and compositions for storing red blood cells for extended periods of time are needed. In particular, improved methods and compositions for preserving red blood cell function for extended periods of time are needed.

### SUMMARY OF THE INVENTION

The present invention provides methods, compositions and kits for storing red blood cells for extended periods of time. In particular, the present invention provides methods, compositions and kits for storing red blood cells for extended periods of time while preventing red blood cell storage lesions, retaining red blood cell deformability, and increasing survival of the red blood cells following transfusion.

In certain embodiments, the present invention provides a composition for preserving red blood cells, wherein the composition comprises at least one potassium sparing agent. In some embodiments, the potassium agent includes, but is not limited to, spironolactone, eplerone, amiloride, triamterene, and any mineralocorticoid receptor blocking agent. In some embodiments, the composition comprises at least one additive agent includes, but is not limited to, adenine, glucose, saline, mannitol, citrate, phosphate, and dextrose. In some embodiments, the composition comprises at least one potassium channel blocker agent. In some embodiments, the potassium channel blocker agent includes, but is not limited to, apamin, clotramazole, cetiedil, charybdotoxin, TEA, and Ba⁺⁺. In some embodiments, the composition comprises at least one nitric oxide donor agent. In some embodiments, the nitric oxide donor agent includes, but is not limited to, nitroglycerin, nitroprusside, nicorandil, sydnonimines agents, statin agents, 1-arginine agents, and tetrahydrobiopterin. In some embodiments, the composition comprises at least one antioxidant agent. In some embodiments, the antioxidant agent includes, but is not limited to, polyphenolic agents, ascordbic acid, fluvastatin, selenium, and α-tocopherol. In some embodiments, the composition is configured to prevent red blood cell storage lesions. In some embodiments, the composition is configured to prevent diminished red blood cell deformability.

The present invention is not limited to a particular method of storing red blood cells with the improved additive compositions of the present invention. In some embodiments, the methods include, but are not limited to, the following steps: 1) obtaining a blood donation from a subject; 2) separating the red blood cells from the plasma thereby forming packed red blood cells (e.g., utilizing any standard laboratory technique; centrifugation); 3) mixing the packed red blood cells with an additive composition (e.g., compositions consisting of adenine-glucose-saline, compositions consisting of adenine-glucose-saline-mannitol, and compositions consisting of adenine-glucose-saline-citrate-phosphate-dextrose) and at least one additional additive agent so as to form a suspension of red blood cells, wherein the at least one additional additive agent comprises one or more of a spironolactone, eplerone, amiloride, triamterene, and any mineralocorticoid receptor blocking agent, TEA, Ba⁺⁺, clotrimazole, cetiedil, nitroglycerin, nitroprusside, nicorandil, sydnonimines agents, statin agents, 1-arginine agents, tetrahydrobiopterin, polyphenolic agents, ascordbic acid, fluvastatin, selenium, α-tocopherol; 4) cooling the suspension of red blood cells (e.g., to about 1 to 6° C.; and 5) storing the cooled suspension of red blood cells (e.g., according to standard blood bank procedures) for a period of, for example, 11 weeks or more.

The present invention provides kits for storing red blood cells comprising, for example, storage bags (e.g., standard red blood cell storage bags), standard additive compositions (e.g., compositions consisting of adenine-glucose-saline, compositions consisting of adenine-glucose-saline-mannitol, and compositions consisting of adenine-glucose-saline-citrate-phosphate-dextrose), at least one additional additive agent (e.g., spironolactone, eplerone, amiloride, triamterene, any mineralocorticoid receptor blocking agent, TEA, Ba⁺⁺, clotrimazole, cetiedil, nitroglycerin, nitroprusside, nicorandil, sydnonimines agents, statin agents, 1-arginine agents, tetrahydrobiopterin, polyphenolic agents, ascordbic acid, fluvastatin, selenium, α-tocopherol), blood collection devices (e.g., standard venapuncture devices), and a blood storage bag (e.g., an industry standard blood storage bag).

### DETAILED DESCRIPTION

Normal red blood cells are flexible and such flexibility permits transit through small spaces (e.g., lung capillaries). The mechanism of adverse outcome observed with some red blood cell transfusions results from red blood cells having storage lesions that compromise its ability to deform. Red blood cell storage lesions affect diffusion and tissue oxygen availability by impairing, for example, microcirculatory hemorheology. Red blood cell deformability is an energy-dependent process, which shows a time-dependent decline during ex vivo storage. Studies have shown that, in a hemorrhagic shock model, transfusion of rat red blood cells stored for 28 days in an additive solution (e.g., saline-adenine-glucose-mannitol or citrate-phosphate-dextrose or citrate-phosphate-dextrose) showed significantly reduced deformability compared with fresh red blood cells (see, e.g., van Bommel J, et al., 2001 Tranfusion 41:1515-1523; incorporated herein by reference in its entirety). Such cells did not improve microvascular P_{O2}, which may be secondary to occlusion of the microcirculation by these nondeformable cells. Stored red blood cells also demonstrate increased aggregation when resuspended in fresh plasma, which can adversely influence microcirculatory rheology by impairing oxygen delivery to tissues (see, e.g., Hovav T, et al., 1999 Transfusion 39:277-281; incorporated herein by reference in its entirety). It was postulated that stored red blood cells lose surface sialic acid residues (negatively charged), which thereby increase their aggregability. This happens particularly in the presence of fibrinogen, an acute phase reactant often increased in the critically ill. Storage-related loss of deformability or increased aggregation may account for impaired microvascular oxygenation following transfusion, an effect reported in preclinical studies (see, e.g., Fitzgerald R D, et al., 1997 Crit. Care Med. 25:726-732; van Bommel J, et al., 2001 Tranfusion 41:1515-1523; each incorporated herein by reference in their entireties).

Red blood cell deformability is decreased in a number of clinical states, including diabetes, sickle cell disease, and sepsis. Numerous studies in both animal and human sepsis using a variety of techniques have documented decreases in red blood cell deformability (see, e.g., Todd J C, et al., 1994 Am Surg 60:954-957; Betticher D C, et al., 1992 Br J Haematol 83:130-137; Powell R J, et al., 1991 Crit Care Med 19:732-735; Davidson L W, et al., 1990 Curr Surg 47: 341-342; each incorporated herein by reference in their entireties). The decreased red blood cell deformability in septic red blood cells has been implicated in altering microvascular hemodynamics with a concomitant decrease in oxygen utilization and tissue ischemia. Multiple mechanisms for reduced red blood cell deformability in sepsis include membrane changes induced by lipid peroxidation oxidative stress, spectrin hemoglobin cross-linking, decreased intracellular ATP, loss of membrane surface sialic acid, and nitric oxide (see, e.g., Piagnerelli M, 2003 Crit. Care Med. 31(8):2156-62; incorporated herein by reference in its entirety). Lipid peroxidation, oxidative stress, and loss of sialic acid residues are likely mediated by release of reactive oxygen species produced by WBCs (see, e.g., Powell R J, et al., 1991 Crit Care Med 19:732-735; Claster S, et al., 1984 Blood 64:1079-1084; Davies K J, et al., 1987 J. Biol. Chem. 262:8220-8226; Powell R J, et al., 1989 Curr Surg 46:380-383; each incorporated herein by reference in their entireties). Similarly, oxidative stress damaging cytoskeletal proteins (see, e.g., Wolfe L C, et al., 1986 J Clin Invest 78:1681-1686; Wagner G M, et al., 1987 Blood 69:1777-1781; Wolfe L, et al., 1985 Blood 66; each incorporated herein by reference in their entireties) or membrane lipids (see, e.g., Knight J V R P, et al., 1992 Transfusion 32:354-357; Racek J, et al., 1997 Vox. Sang. 72:16-19; Knight J A, et al., 1994 Ann Clin Lab Sci 24:294-301; Wolfe L C, 1989 Semin Hemat 26:307-312; Deepa Devi K V, et al., 1998 Vox Sang 75:198-204; Knight J A, 1996 Ann Clin Lab Sci 26:283-290; Knight J A, et al., Ann Clin Lab Sci 1993; 23:178-183; each incorporated herein by reference in their entireties), loss of sialic acid (see, e.g., Hovav T, et al., 1999 Transfusion 39:277-281; incorporated herein by reference in its entirety), and reduced ATP (see, e.g., Nakao M, et al., 1960 Nature 187:945-946; incorporated herein by reference in its entirety) have been implicated in the red blood cell storage lesion.

The ability for red blood cells to deform depends on, for example, nitric oxide and intracellular K content and their interrelationship. Red blood cells have been shown to be capable of producing nitric oxide (see, e.g., Kleinbongard, et al., 2006 Blood 107(7):2943-2951; incorporated herein by reference in its entirety), and nitric oxide synthase inhibitors have been shown to significantly reduce red blood cell deformability, whereas nitric oxide donors and K channel blocker (TEA) increased deformability (see, e.g., Bor-Kucukatay, et al., 2003 Am J Physiol Heart Circ Physiol. 284(5):H1577-84; incorporated herein by reference in its entirety). In addition, during early red blood cell storage, significant amounts of K are reversed in the extracellular medium, due to leakage from red blood cell and to the block of Na pump at 4° C. (see, e.g., Minetti et al., 2001 Biochim Biophys Acta. 1527(3):149-155; incorporated herein by reference in its entirety). Red blood cell related potassium loss is a complex and cell age-dependent process. In the absence of other osmotic process, K loss results in overall cell shrinkage. After reinfusion, the alterations that cells have suffered during storage begin to reverse. For example, lactate rapidly diffuses out of the cells, the levels of 2,3-BPG and ATP begin to rise, and cells recover, although at a slower rate, from the imbalance in monovalent cations. However, red blood cells that suffered from excessive swelling (e.g., red blood cells having storage lesions) are unable to recover promptly. In addition, increased oxidative stress has been shown to alter in erythrocyte rheology and facilitate potassium leak. For example, hypochlorous acid, a powerful natural oxidant, has been shown to produce, prior to hemolysis, changes in erythrocyte deformability evidenced by ektacytometry, and an increase in K leak (see, e.g., Vissers, et al., 1994 Free Radic. Biol. Med. 16(6):703-712; incorporated herein by reference in its entirety). For example, incubation of red blood cells with an antioxidant component such as a polyphenol agent prevents rheology alterations and hemolysis caused by hypochlorous acid (see, e.g., Suwalsky, M., et al., 2006 Food Chem. Toxicol. 44(8):1393-1398; incorporated herein by reference in its entirety). Consequently, there remains a need for improved additive solutions and processes which will preserve red blood cell function during prolong storage as well as increase survival after transfusion.

Accordingly, the present invention provides improved additive compositions configured for storing red blood cells for extended periods of time while preventing red blood cell storage lesions, retaining red blood cell deformability, and increasing survival of the red blood cells following transfusion. The improved additive compositions configured for storing red blood cells for extended periods of time may be used at any temperature range (e.g., 1 to 6° C.). The improved additive compositions configured for storing red blood cells for extended periods may be directly infused into any type of animal (e.g., mammals), including but not limited to, dogs, cats, cows, humans, primates, etc. The improved additive compositions configured for storing red blood cells for extended periods may be used in any type of setting (e.g., military, hospital, clinic).

The present invention is not limited to a particular method or manner of improving upon standard additive compositions configured for storing red blood cells. In some embodiments, the present invention improves upon standard additive compositions by providing additional agents to the additive compositions. The present invention is not limited to a particular type or kind of standard additive composition configured for storing red blood cells. Examples of standard additive-compositions for storing red blood cells include, but are not limited to, compositions consisting of adenine-glucose-saline, compositions consisting of adenine-glucose-saline-mannitol, and compositions consisting of adenine-glucose-saline-citrate-phosphate-dextrose (see, e.g., Hess, J. R., 2006 Vox Sanguinis 91:13-19; U.S. Pat. Nos. 6,770,478, 6,527,957, 6,267,925, 5,789,151, 5,250,303, 5,248,506, 5,147,776, 4,812,310, 4,585,735; each incorporated herein by reference in their entireties). The present invention is not limited to providing a particular type or types of additional agent(s) to standard additive compositions configured for storing red blood cells. In some embodiments, the additional agent(s) is provided as, for example, a time-release pellet at multiple times during the extended storage of the red blood cells. In some embodiments, the additional agent(s) is provided at the beginning of the extended storage of the red blood cells.

In some embodiments, at least one potassium sparing drug is provided to standard additive compositions configured for storing red blood cells. The present invention is not limited to a particular type or kind of potassium sparing drug (e.g., spironolactone, eplerone, amiloride, triamterene, and any mineralocorticoid receptor blocking agent). The present invention is not limited to providing a particular amount of a potassium sparing drug to a standard additive composition configured for storing red blood cells. In some embodiments, the amount of potassium sparing drug(s) provided is sufficient to prevent storage related potassium leakage from the red blood cells. In some embodiments, the amount of potassium sparing drug(s) provided is sufficient to permit prolonged storage of red blood cells while preventing red blood cell storage lesions, retaining red blood cell deformability, and increasing survival of the red blood cells following transfusion.

In some embodiments, at least one potassium channel blocker agent is provided to standard additive compositions configured for storing red blood cells. The present invention is not limited to a particular type or kind of potassium channel blocker agent (e.g., apamin, clotramazole, cetiedil, charybdotoxin, TEA, Ba⁺⁺). The present invention is not limited to provide a particular amount of a potassium channel blocker agent to a standard additive composition configured for storing red blood cells. In some embodiments, the amount of potassium channel blocker agent(s) provided is sufficient to permit prolonged storage of red blood cells while preventing red blood cell storage lesions, retaining red blood cell deformability, and increasing survival of the red blood cells following transfusion.

In some embodiments, at least one nitric oxide donor agent is provided to standard additive compositions configured for storing red blood cells. The present invention is not limited to a particular type or kind of nitric oxide donor agent (e.g., nitroglycerin, nitroprusside, nicorandil, sydnonimines agents, statin agents, 1-arginine agents, tetrahydrobiopterin). The present invention is not limited to provide a particular amount of a nitric oxide donor agent to a standard additive composition configured for storing red blood cells. In some embodiments, the amount of nitric oxide donor agent(s) provided is sufficient to permit prolonged storage of red blood cells while preventing red blood cell storage lesions, retaining red blood cell deformability, and increasing survival of the red blood cells following transfusion.

In some embodiments, at least one antioxidant agent is provided to standard additive compositions configured for storing red blood cells. The present invention is not limited to a particular type or kind of antioxidant agent (e.g., polyphenolic agents, ascordbic acid, fluvastatin, selenium, α-tocopherol). The present invention is not limited to provide a particular amount of a antioxidant agent to a standard additive composition configured for storing red blood cells. In some embodiments, the amount of antioxidant agent(s) provided is sufficient to permit prolonged storage of red blood cells while preventing red blood cell storage lesions, retaining red blood cell deformability, and increasing survival of the red blood cells following transfusion.

In some embodiments, any one or more combinations of a potassium sparing drug, a potassium channel blocker agent, a nitric oxide donor agent, and an antioxidant agent may be provided to standard additive compositions configured for storing red blood cells for purposes of, for example, prolonging storage of red blood cells while preventing red blood cell storage lesions, retaining red blood cell deformability, and increasing survival of the red blood cells following transfusion.

The present invention is not limited to a particular method of storing red blood cells with the improved additive compositions of the present invention. In some embodiments, the methods include, but are not limited to, the following steps: 1) obtaining a blood donation from a subject; 2) separating the red blood cells from the plasma thereby forming packed red blood cells (e.g., utilizing any standard laboratory technique; centrifugation); 3) mixing the packed red blood cells with a standard additive composition (e.g., compositions consisting of adenine-glucose-saline, compositions consisting of adenine-glucose-saline-mannitol, and compositions consisting of adenine-glucose-saline-citrate-phosphate-dextrose) and at least one additional additive agent so as to form a suspension of red blood cells, wherein the at least one additional additive agent is selected from the group consisting of a spironolactone, eplreone, amiloride, triamterene, TEA, Ba⁺⁺, clotrimazole, cetiedil, nitroglycerin, nitroprusside, nicorandil, sydnonimines agents, statin agents, 1-arginine agents, tetrahydrobiopterin, polyphenolic agents, ascordbic acid, fluvastatin, selenium, α-tocopherol; 4) cooling the suspension of red blood cells (e.g., to about 1 to 6° C.; and 5) storing the cooled suspension of red blood cells (e.g., according to standard blood bank procedures) for a period of, for example, 11 weeks or more.

The present invention provides kits for storing red blood cells comprising, for example, storage bags (e.g., standard red blood cell storage bags), standard additive compositions (e.g., compositions consisting of adenine-glucose-saline, compositions consisting of adenine-glucose-saline-mannitol, and compositions consisting of adenine-glucose-saline-citrate-phosphate-dextrose), at least one additional additive agent (e.g., spironolactone, eplerone, amiloride, triamterene, TEA, Ba⁺⁺, clotrimazole, cetiedil, nitroglycerin, nitroprusside, nicorandil, sydnonimines agents, statin agents, 1-arginine agents, tetrahydrobiopterin, polyphenolic agents, ascordbic acid, fluvastatin, selenium, α-tocopherol), blood collection devices (e.g., standard venapuncture devices), and a blood storage bag (e.g., an industry standard blood storage bag).

In some embodiments, the present invention blood samples containing the compositions for red blood cell preservation of the present invention are periodically tested so as to assure proper red blood cell quality. Any type of method may be used to assess red blood cell quality during the prolonged storage (e.g., use of cellulose strips (or other solid surfaces) having antibodies (e.g., a predefined number of antibodies so as to bind a known amount of sample) specific, for example, for non-healthy red blood cells, or any type of attribute of a non-functional red blood cell).

In some embodiments, the health of a subject who as received a blood transfusion with blood having been stored with the compositions of the present invention is periodically tested so as to assure proper red blood cell quality. Any type of method may be used to assess red blood cell quality during the prolonged storage (e.g., use of cellulose strips (or other solid surfaces) having antibodies (e.g., a predefined number of antibodies so as to bind a known amount of sample) specific, for example, for non-healthy red blood cells, or any type of attribute of a non-functional red blood cell).

All publications and patents mentioned in the above specification are herein incorporated by reference. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We Claim:

1. A composition for red blood cell preservation comprising at least one potassium sparing agent and an additive-composition comprising saline, adenine and glucose.

2. The composition of claim 1, wherein said potassium agent is selected from the group consisting of spironolactone, eplereone, amiloride, and triamterene.

3. The composition of claim 1, wherein said additive-composition further comprises at least one additive agent selected from the group consisting of mannitol, citrate, phosphate, and dextrose.

4. The composition of claim 1, further comprising at least one potassium channel blocker agent.

5. The composition of claim 4, wherein said potassium channel blocker agent is selected from the group consisting of apamin, clotramazole, cetiedil, charybdotoxin, TEA, and Ba⁺⁺.

6. The composition of claim 1, further comprising at least one nitric oxide donor agent.

7. The composition of claim 6, wherein said nitric oxide donor agent is selected from the group consisting of nitroglycerin, nitroprusside, nicorandil, sydnonimines agents, statin agents, 1-arginine agents, and tetrahydrobiopterin.

8. The composition of claim 1, further comprising at least one antioxidant agent.

9. The composition of claim 8, wherein said antioxidant agent is selected from the group consisting of polyphenolic agents, ascordbic acid, fluvastatin, selenium, and α-tocopherol.

10. The composition of claim 1, wherein said composition is configured to prevent red blood cell storage lesions.

11. The composition of claim 1, wherein said composition is configured to preserve red blood cell deformability.

12. A method of preserving red blood cells, comprising:
providing red blood cells and a composition for red blood cell preservation, wherein said composition comprises at least one potassium sparing agent and an additive-composition comprising saline, adenine and glucose; and
contacting said red blood cells and said composition such that said red blood cells and said additive composition form a suspension.

13. The method of claim 12, further comprising the step:
cooling said suspension.

14. The method of claim 13, further comprising the step:
storing said cooled suspension for at least 2 weeks.

15. The method of claim 12, wherein said potassium agent is selected from the group consisting of spironolactone, eplereone, amiloride, and triamterene.

16. The method of claim 12, wherein said additive-composition further comprises at least one additive agent selected from the group consisting of mannitol, citrate, phosphate, and dextrose.

17. The method of claim 12, further comprising at least one potassium channel blocker agent.

18. The method of claim 17, wherein said potassium channel blocker agent is selected from the group consisting of apamin, clotramazole, cetiedil, charybdotoxin, TEA, and Ba⁺⁺.

19. The method of claim 12, further comprising at least one nitric oxide donor agent.

20. The method of claim 19, wherein said nitric oxide donor agent is selected from the group consisting of nitroglycerin, nitroprusside, nicorandil, sydnonimines agents, statin agents, 1-arginine agents, and tetrahydrobiopterin.

21. The method of claim 12, further comprising at least one antioxidant agent.

22. The method of claim 21, wherein said antioxidant agent is selected from the group consisting of polyphenolic agents, ascordbic acid, fluvastatin, selenium, and α-tocopherol.

23. The method of claim 12, wherein said composition is configured to prevent red blood cell storage lesions.

24. The method of claim 23, wherein said composition is configured to preserve red blood cell deformability.

25. A kit for preserving red blood cells, comprising venapuncture devices and a composition for red blood cell preservation, wherein said composition comprises at least one potassium sparing agent and an additive-composition comprising saline, adenine and glucose.

26. The kit of claim 25, wherein said potassium agent is selected from the group consisting of spironolactone, eplereone, amiloride, and triamterene.

27. The kit of claim 25, wherein said additive-composition further comprises at least one additive agent selected from the group consisting of mannitol, citrate, phosphate, and dextrose.

28. The kit of claim 25, further comprising at least one potassium channel blocker agent.

29. The kit of claim 28, wherein said potassium channel blocker agent is selected from the group consisting of apamin, clotramazole, cetiedil, charybdotoxin, TEA, and Ba⁺⁺.

30. The kit of claim 25, further comprising at least one nitric oxide donor agent.

31. The kit of claim 30, wherein said nitric oxide donor agent is selected from the group consisting of nitroglycerin, nitroprusside, nicorandil, sydnonimines agents, statin agents, 1-arginine agents, and tetrahydrobiopterin.

32. The kit of claim 25, further comprising at least one antioxidant agent.

33. The kit of claim 32, wherein said antioxidant agent is selected from the group consisting of polyphenolic agents, ascordbic acid, fluvastatin, selenium, and α-tocopherol.

34. The kit of claim 25, wherein said composition is configured to prevent red blood cell storage lesions.

35. The kit of claim 34, wherein said composition is configured to preserve red blood cell deformability.

36. The kit of claim 25, further comprising a blood storage bag.
